(19) United States
(12) Patent Application Publication
(10) Pub. No.: US 2023/0275485 A1
(43) Pub. Date: Aug. 31, 2023

(54) MOTOR

(71) Applicant: LG INNOTEK CO., LTD., Seoul (KR)

(72) Inventor: Yong Chul KIM, Seoul (KR)

(73) Assignee: LG INNOTEK CO., LTD., Seoul (KR)

(21) Appl. No.: 18/008,092

(22) PCT Filed: Jun. 4, 2021
(86) PCT No.: PCT/KR2021/007024

§ 371 Date: Dec. 2, 2022

(30) Foreign Application Priority Data
Jun. 4, 2020 (KR) 10-2020-0067427

(51) Int. Cl. H02K 3/52

(52) U.S. Cl. CPC H02K 3/522; H02K 2203/12

(57) ABSTRACT

The present invention may provide a motor including a rotor and a stator disposed to correspond to the rotor, wherein the stator includes a stator core, an insulator coupled to the stator core, and a coil disposed around the insulator, the insulator includes an upper plate disposed on an upper surface of the stator core, a first side plate extending from one end of the upper plate and disposed on one side surface of the stator, and a second side plate extending from the other end of the upper plate and disposed on the other side surface of the stator, the second side plate includes a first region extending from the other end of the upper plate and a second region extending from the first region and disposed on a lower surface of the stator, and the second region is bent from the first region.

### TECHNICAL FIELD

The present invention relates to a motor.

### BACKGROUND ART

A motor includes a rotor and a stator. The stator may include a stator core, an insulator installed on the stator core, and a coil wound around the insulator.

The insulator may include an upper insulator and a lower insulator. The upper insulator may be disposed on the stator core. The lower insulator may be disposed under the stator core. The upper insulator and the lower insulator are combined and installed on the stator core, and the insulator insulates the stator core from the coil.

However, a gap may be formed between the upper insulator and the lower insulator, and thus a region of the stator core corresponding to the coil may not be completely covered by the insulator and may be exposed. There is a problem that the exposed region of the stator core is not electrically insulated from the coil.

### Technical Problem

The present invention is directed to providing a motor in which a region not covered by an insulator and exposed is eliminated in a region of a stator core corresponding to a coil.

Objectives to be solved by the present invention are not limited to the above-described objectives, and other objectives which are not described above will be clearly understood by those skilled in the art from the following specification.

### Technical Solution

One aspect of the present invention provides a motor including a rotor and a stator disposed to correspond to the rotor, wherein the stator includes a stator core, an insulator coupled to the stator core, and a coil disposed around the insulator, the insulator includes an upper plate disposed on an upper surface of the stator core, a first side plate extending from one end of the upper plate and disposed on one side surface of the stator, and a second side plate extending from the other end of the upper plate and disposed on the other side surface of the stator, the second side plate includes a first region extending from the other end of the upper plate and a second region extending from the first region and disposed on a lower surface of the stator, and the second region is bent from the first region.

A position at which the second region is bent may correspond to a boundary between the upper surface and the side surface of the stator core or a boundary between a lower surface and the side surface of the stator core.

Another aspect of the present invention provides a motor including a rotor and a stator disposed to correspond to the rotor, wherein the stator includes a stator core, an insulator coupled to the stator core, and a coil disposed around the insulator, the insulator includes an upper plate disposed on an upper surface of the stator core, a first side plate extending from one end of the upper plate and disposed on one side surface of the stator, and a second side plate extending from the other end of the upper plate and disposed on the other side surface of the stator, the second side plate includes a first region extending from the other end of the upper plate and a second region extending from the first region and disposed on a lower surface of the stator, and a fold groove is formed between the first region and the second region.

The fold groove may be disposed to correspond to a boundary between the upper surface and the side surface of the stator core or a boundary between a lower surface and the side surface of the stator core.

The first side plate may include a third region extending from the other end of the upper plate and a fourth region extending from the third region, an end of the fourth region may include a first overlap portion having a thickness smaller than a thickness of the third region, an end of the second region may include a second overlap portion having a thickness smaller than a thickness of the first region, and the first overlap portion may overlap the second overlap portion in a direction perpendicular to an axial direction.

The first overlap portion may be disposed closer to the stator core than the second overlap portion.

The second overlap portion may be disposed closer to the stator core than the first overlap portion.

The first overlap portion may include a first contact surface, the second overlap portion may include a second contact surface in contact with the first contact surface, and the first contact surface and the second contact surface may be obliquely disposed with respect to a direction perpendicular to the axial direction.

Still another aspect of the present invention provides a motor including a rotor and a stator disposed to correspond to the rotor, wherein the stator includes a stator core, an insulator coupled to the stator core, and a coil disposed around the insulator, the insulator includes an upper plate which covers an upper surface of the stator, a first side plate which extends from one end of the upper plate and covers one side surface of the stator, and a second side plate which extends from the other end of the upper plate and covers the other side surface of the stator, the second side plate includes a first region extending from the other end of the upper plate and a second region extending from the first region and disposed on a lower surface of the stator, the second region is bent from the first region, the first side plate includes a third region and a fourth region extending from the third region, an end of the fourth region includes a first overlap portion having a thickness smaller than a thickness of the third region, an end of the second region includes a second overlap portion having a thickness smaller than a thickness of the first region, and the first overlap portion overlaps the second overlap portion in a direction parallel to an axial direction.

A fold groove may be disposed between the fourth region and the third region.

The fold groove may be disposed to correspond to a boundary between an upper surface and a side surface of the stator core or a boundary between a lower surface and the side surface of the stator core.

The first overlap portion may include a first contact surface, the second overlap portion may include a second contact surface in contact with the first contact surface, and the first contact surface and the second contact surface may be obliquely disposed with respect to a direction perpendicular to the axial direction.

The first overlap portion may include a first contact surface, the second overlap portion may include a second contact surface in contact with the first contact surface, and the first contact surface and the second contact surface may be disposed in parallel in a direction perpendicular to the axial direction.

The insulator may include an inner guide and an outer guide, and the second region may be disposed apart from the inner guide and the outer guide.

The insulator may include an inner guide and an outer guide, and the fourth region may be disposed apart from the inner guide and the outer guide.

### Advantageous Effects

According to embodiments, since a region, which is not covered by an insulator and exposed, can be eliminated in a region of a stator core corresponding to a coil, there is an advantage that an insulation problem occurring between the coil and the stator core is eliminated.

Accordingly, there is an advantage of omitting various types of safety designs to be added to supplement a case in which the insulation problem occurs.

According to the embodiments, since the stator core can be entirely covered by one insulator, there is an advantage that a manufacturing process of a motor can be quickly performed.

### DESCRIPTION OF DRAWINGS

FIG. 1 is a view illustrating a motor according to an embodiment.

FIG. 2 is a perspective view illustrating an insulator.

FIG. 3 is a side cross-sectional view illustrating a state in which the insulator illustrated in FIG. 2 is installed on a stator core.

FIG. 4 is a side cross-sectional view illustrating a state in which a second region of the insulator illustrated in FIG. 2 rotates.

FIG. 5 is a view illustrating a state in which a first side plate and a second side plate of the insulator are coupled and cover the stator core.

FIG. 6 is a side cross-sectional view illustrating another insulator having a different coupling structure of a first side plate and a second side plate from that of the insulator illustrated in FIG. 2.

FIG. 7 is a perspective view illustrating still another insulator.

FIG. 8 is a side cross-sectional view illustrating a state in which the insulator illustrated in FIG. 7 is installed on a stator core.

FIG. 9 is a side cross-sectional view illustrating a state in which a second region of the insulator illustrated in FIG. 7 rotates.

FIG. 10 is a view illustrating a state in which a first side plate and a second side plate of the insulator illustrated in FIG. 7 are coupled and cover the stator core.

FIG. 11 is a side cross-sectional view illustrating yet another insulator having a different coupling structure of a first side plate and a second side plate from that of the insulator illustrated in FIG. 7.

### MODES OF THE INVENTION

Hereinafter, exemplary embodiments of the present invention will be described in detail with reference to the accompanying drawings.

However, the technical spirit of the present invention is not limited to some embodiments which will be described and may be implemented using various other embodiments, and at least one component of the embodiments may be selectively coupled, substituted, and used within the range of the technical spirit of the present invention.

In addition, unless clearly and specifically defined otherwise by context, all terms (including technical and scientific terms) used herein can be interpreted as having meanings customarily understood by those skilled in the art, and meanings of generally used terms, such as those defined in commonly used dictionaries, will be interpreted by considering contextual meanings of the related technology.

In addition, the terms used in the embodiments of the present invention are considered in a descriptive sense and not for limiting the present invention.

In the present specification, unless specifically indicated otherwise by the context, singular forms may include the plural forms thereof, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” can be used.

The terms are only to distinguish one element from another element, and an essence, order, and the like of the element are not limited by the terms.

In addition, when an element is referred to as being “connected” or “coupled” to another element, such a description may include not only a case in which the element is directly connected or coupled to another element but also a case in which the element is connected or coupled to another element with still another element disposed therebetween.

In addition, in a case in which any one element is described as being formed or disposed “on” or “under” another element, such a description includes not only a case in which the two elements are formed or disposed in direct contact with each other but also a case in which one or more other elements are formed or disposed between the two elements. In addition, when one element is described as being disposed “on or under” another element, such a description may include a case in which the one element is disposed at an upper side or lower side with respect to another element.

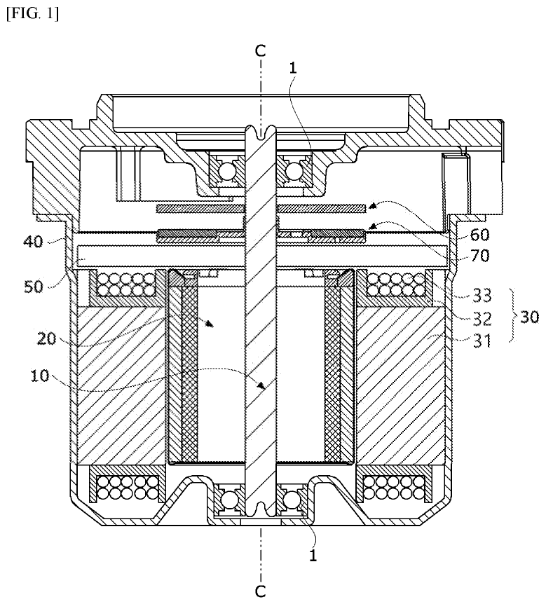

FIG. 1 is a view illustrating a motor according to an embodiment.

Referring to FIG. 1, the motor according to the embodiment may include a shaft 10, a rotor 20, a stator 30, and a housing 40. Hereinafter, the term “inward” refers to a direction from the housing 40 toward the shaft 10 which is a center of the motor, and the term “outward” refers to a direction opposite to “inward,” that is, a direction from the shaft 10 toward the housing 40. In addition, a circumferential direction or radial direction is defined based on an axial center.

The shaft 10 may be coupled to the rotor 20. When an electromagnetic interaction occurs between the rotor 20 and the stator 30 after a current is supplied, the rotor 20 rotates, and the shaft 10 rotates in conjunction with the rotor 20.

The rotor 20 rotates due to an electrical interaction with the stator 30. The rotor 20 may be disposed to correspond to the stator 30 and disposed inside the stator 30. The rotor 20 may include a magnet.

The stator 30 is disposed outside the rotor 20. The stator 30 may include a stator core 31, an insulator 32, a coil 33. The insulator 32 is installed on the stator core 31. The coil 33 may be wound around the insulator 32. The insulator 32 is disposed between the coil 33 and the stator core 31 to electrically insulate the stator core 31 from the coil 33. The coil 33 induce an electrical interaction with the magnet of the rotor 20.

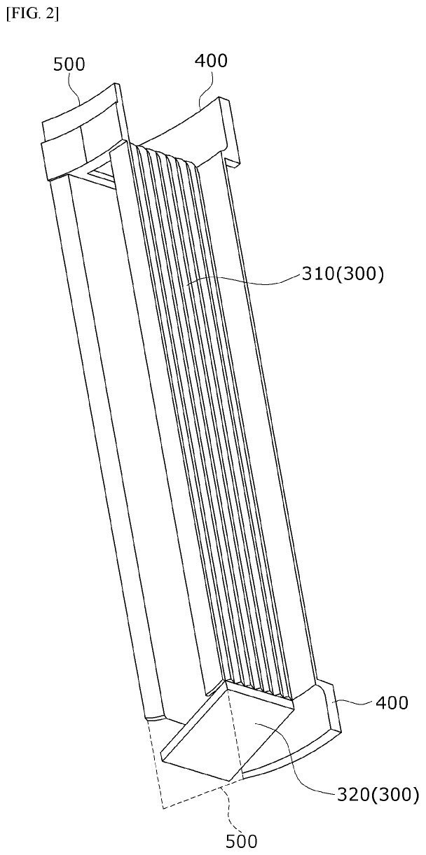

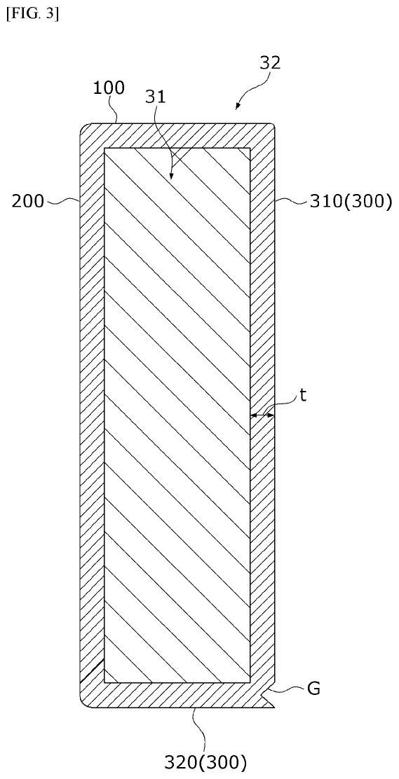

FIG. 2 is a perspective view illustrating the insulator 32, and FIG. 3 is a side cross-sectional view illustrating a state in which the insulator 32 illustrated in FIG. 2 is installed on the stator core 31.

Referring to FIGS. 2 and 3, the insulator 32 is a single member and covers an entire region of the stator core 31 corresponding to the coil 33. Accordingly, an exposed region in a region of the stator core 31 corresponding to the coil 33 may be eliminated. The insulator 32 is assembled with the stator core 31. Accordingly, the insulator 32 has a structure in which a space, through which the stator core 31 enters, is secured in insulator 32 and which is capable of covering the entire region of the stator core 31 corresponding to the coil 33.

The insulator 32 includes a body around which the coil 33 is wound, and the body may include an upper plate 100, a first side plate 200, and a second side plate 300. The upper plate 100, the first side plate 200, and the second side plate 300 are connected as a single member. The upper plate 100 may be disposed on an upper surface of the stator core 31. The first side plate 200 may be disposed on one side surface of the stator core 31. A part of the second side plate 300 may be disposed on the other side surface of the stator core 31, and another part of the second side plate 300 may be disposed on a lower surface of the stator core 31. The first side plate 200 may be disposed to extend from one end of the upper plate 100. The second side plate 300 may be disposed to extend from the other end of the upper plate 100.

The insulator 32 is installed on the stator core 31 to surround all the upper surface, the two side surfaces, and the lower surface of the stator core 31.

The second side plate 300 may include a first region 310 and a second region 320.

The first region 310 is a portion extending from the other end of the upper plate 100. The second region 320 is a region extending from the first region 310 and disposed on the lower surface of the stator core 31. The second region 320 is disposed to be bent from the first region 310. The second region 320 may be connected to the first region 310 to be bent so as to secure a space, through which the stator core 31 enters, in the insulator 32. To this end, a fold groove G may be disposed between the first region 310 and the second region 320. The second region 320 may rotate about the fold groove G.

The fold groove G may be disposed to correspond to a boundary between the side surface and the lower surface of the stator core 31 when the insulator 32 is installed on the stator core 31. This is to guide the insulator 32 to be bent around a corner of the stator core 31.

The insulator 32 may include an inner guide 400 and an outer guide 500. The second region 320 may be disposed to be separated from the inner guide 400 and the outer guide 500.

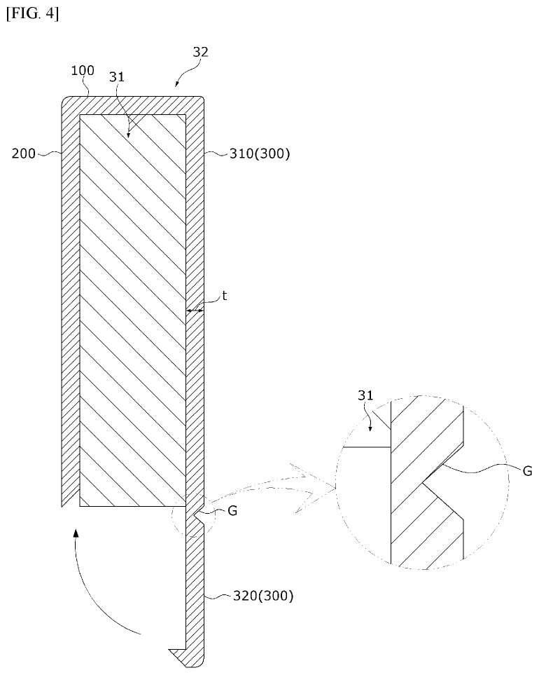

FIG. 4 is a side cross-sectional view illustrating a state in which the second region 320 of the insulator 32 illustrated in FIG. 2 rotates.

Referring to FIGS. 3 and 4, the second region 320 of the insulator 32 rotates about the fold groove G. This is to secure the space, through which the stator core 31 enters, in the insulator 32. In a state in which the second region 320 is open, that is, before the first side plate 200 and the second side plate 300 are coupled, the stator core 31 is inserted into the insulator 32. Then, when the second region 320 is closed, in a state in which the second region 320 is disposed on the lower surface of the stator core 31, an end portion of the second region 320 of the second side plate 300 is in contact with and coupled to an end portion of the first side plate 200. In this case, the end portion of the second region 320 of the second side plate 300 may be press-fitted to be coupled to the end portion of the first side plate 200.

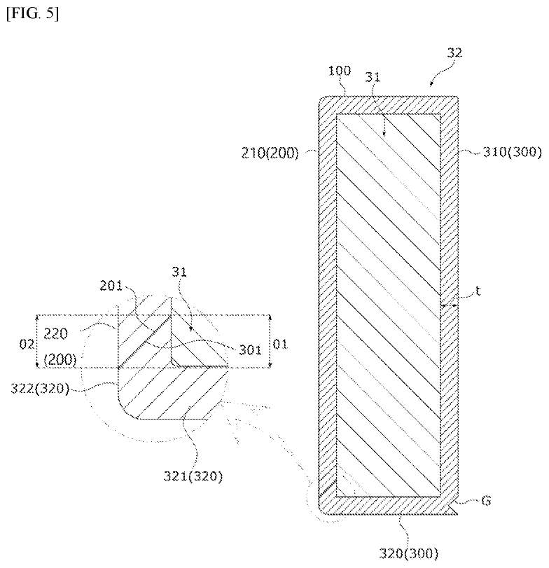

FIG. 5 is a view illustrating a state in which the first side plate 200 and the second side plate 300 of the insulator 32 are coupled and cover the stator core 31.

Referring to FIGS. 4 and 5, in a state in which the second region 320 of the second side plate 300 rotates to cover the lower surface of the stator core 31, when the first side plate 200 and the second side plate 300 are coupled, the entire region of the stator core 31 corresponding to the coil 33 are covered to eliminate a region in which the stator core 31 is exposed.

The second region 320 may be divided into a first part 321 and a second part 322. The first part 321 is a part extending from the first region 310, and the second part 322 is a part bent from the first part 321. An inner surface of the first part 321 may be disposed on the lower surface of the stator core 31. An inner surface of the second part 322 may be disposed on one side surface of the stator core 31. The second part 322 may be in contact with the end portion of the first side plate 200.

The first side plate 200 may include a third region 210 and a fourth region 220. The third region 210 extends from the other end of the upper plate 100. The fourth region 220 extends from the third region 210. An end portion of the third region 210 may be coupled to the second region 320 of the second side plate 300. An end of the fourth region 220 may include a first overlap portion O1 having a thickness t smaller than that of the third region 210. The end of the second region 320 may include a second overlap portion O2 having a thickness t smaller than that of the first region 310. The first overlap portion O1 and the second overlap portion O2 may overlap in a direction perpendicular to an axial direction. The first overlap portion O1 may be disposed closer to the stator core 31 than the second overlap portion O2.

The first overlap portion O1 may include a first contact surface 301. In addition, the second overlap portion O2 may include a second contact surface 302. The first contact surface 301 and the second contact surface 302 are in contact with each other. The first contact surface 301 and the second contact surface 302 may include a protruding structure and a groove structure having various shapes engaged with each other. The first contact surface 301 and the second contact surface 302 may be obliquely disposed with respect to a direction perpendicular to the axial direction.

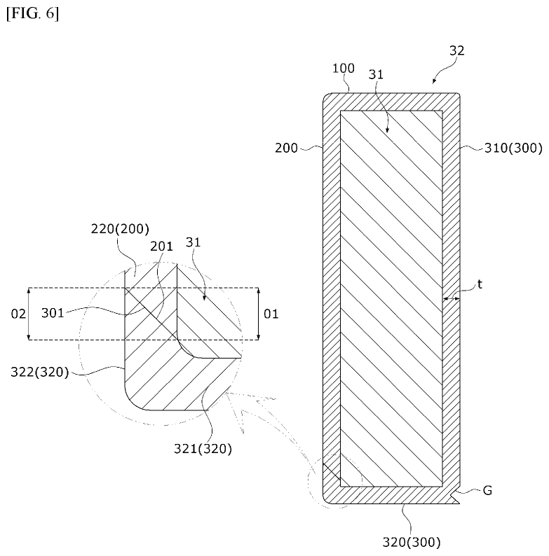

FIG. 6 is a side cross-sectional view illustrating another insulator 32 having a different coupling structure of a first side plate 200 and a second side plate 300 from that of the insulator 32 illustrated in FIG. 2.

Referring to FIG. 6, in another insulator 32 according to an embodiment, a first overlap portion O1 and a second overlap portion O2 may be disposed to overlap in a direction perpendicular to an axial direction, and the second overlap portion O2 may be disposed closer to a stator core 31 than the first overlap portion O1. Accordingly, an inner surface of a second part 322 of a second region 320 is not in contact with the stator core 31, and an inner surface of the second overlap portion O2 of a fourth region 220 of the first side plate 200 may be disposed in contact with the stator core 31.

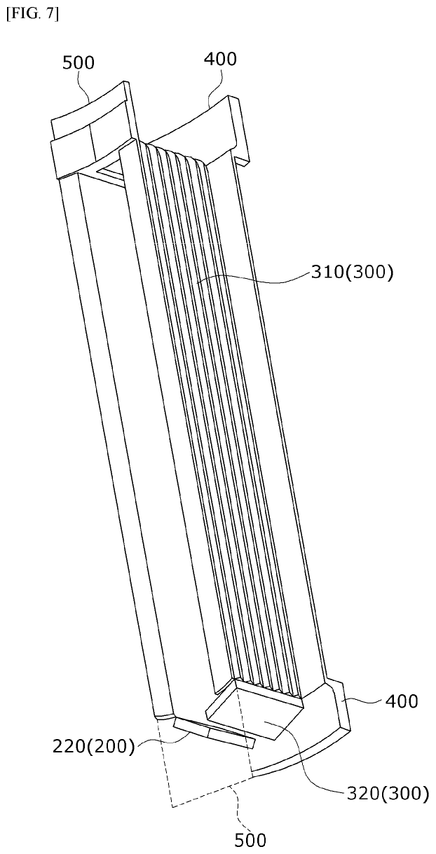

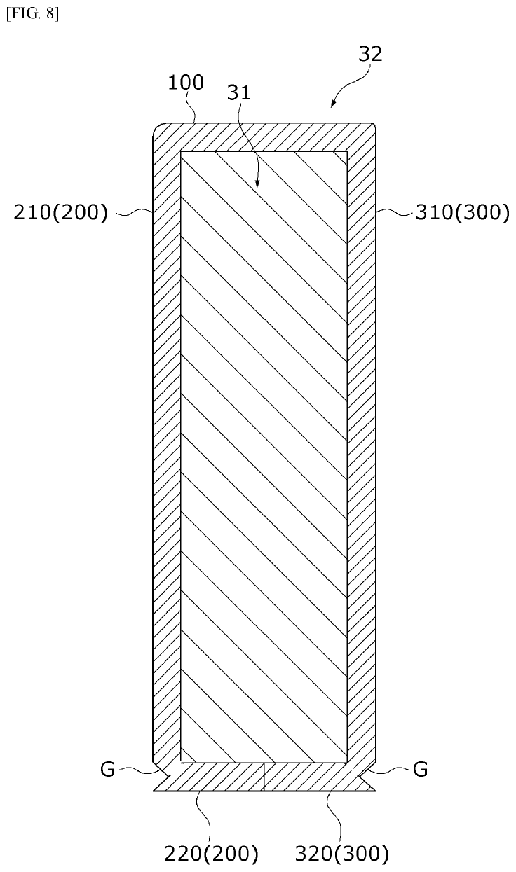

FIG. 7 is a perspective view illustrating still another insulator 32, and FIG. 8 is a side cross-sectional view illustrating a state in which the insulator 32 illustrated in FIG. 7 is installed on a stator core 31.

Referring to FIGS. 7 and 8, in still another insulator 32, there is a feature that a fold groove G is disposed between a first region 310 and a second region 320, and a fold groove G is disposed between a third region 210 and a fourth region 220. In addition, the second region 320 and the fourth region 220 are disposed on a lower surface of the stator core 31.

The second region 320 may be disposed to be separated from an inner guide 400 and an outer guide 500. The fourth region 320 may also be disposed to be separated from the inner guide 400 and the outer guide 500.

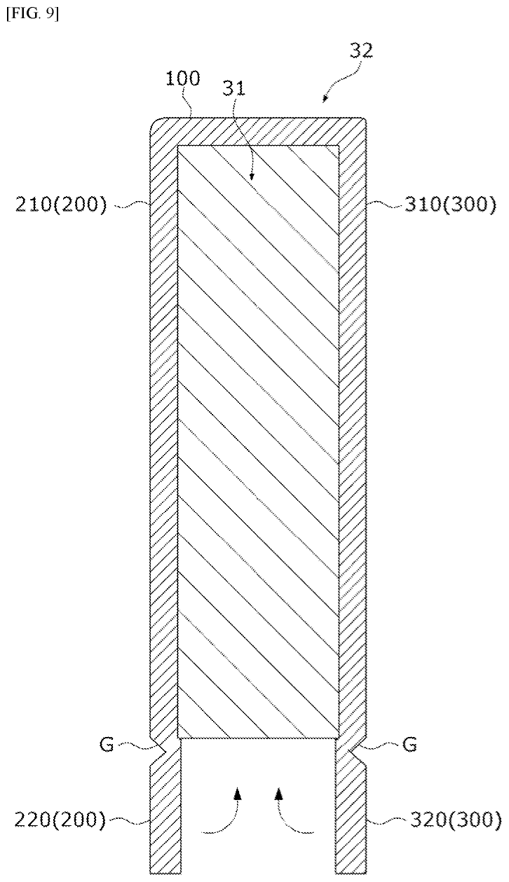

FIG. 9 is a side cross-sectional view illustrating a state in which the second region 320 of the insulator 32 illustrated in FIG. 7 rotates.

Referring to FIGS. 8 and 9, the second region 320 of the insulator 32 rotates about the fold groove G. In addition, the fourth region 220 of the insulator also rotates about the fold groove G. This is to secure a space, through which the stator core 31 enters, in the insulator 32. In a state in which the second region 320 and the fourth region 220 are open, that is, before a first side plate 200 and a second side plate 300 are coupled, the stator core 31 is inserted into the insulator 32. Then, when the second region 320 and the fourth region 220 are closed, in a state in which the second region 320 and the fourth region 220 are disposed on the lower surface of the stator core 31, an end portion of the second region 320 of the second side plate 300 is in contact with and is coupled to an end portion of the fourth region 220 of the first side plate 200. In this case, the end portion of the second region 320 of the second side plate 300 may be press-fitted to be coupled to an end portion of the first side plate 200 of the fourth region 220.

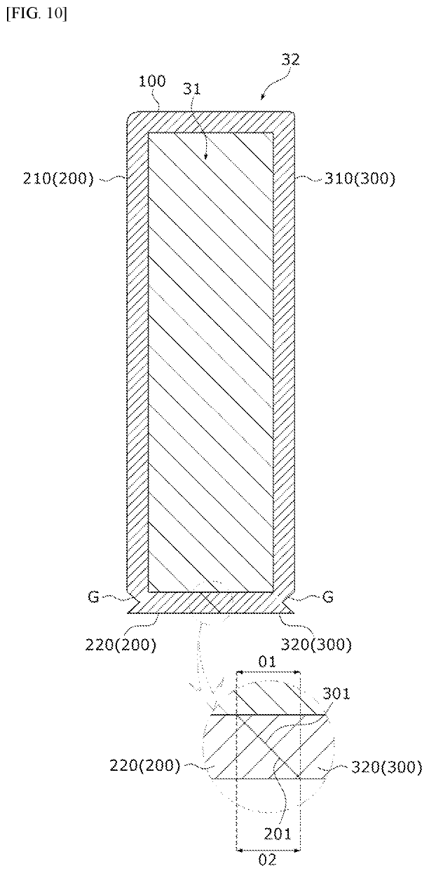

FIG. 10 is a view illustrating a state in which the first side plate 200 and the second side plate 300 of the insulator 32 illustrated in FIG. 7 are coupled and cover the stator core 31.

Referring to FIG. 10, a first overlap portion O1 and a second overlap portion O2 may overlap in a direction parallel to an axial direction.

A first contact surface 301 and a second contact surface 302 are in contact with each other. The first contact surface 301 and the second contact surface 302 may have a protruding structure and a groove structure having various shapes engaged with each other. The first contact surface 301 and the second contact surface 302 may be obliquely disposed with respect to a direction parallel to the axial direction.

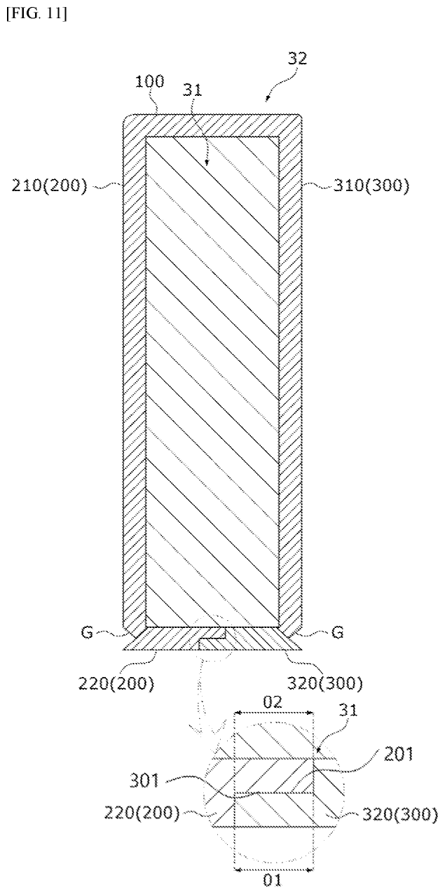

FIG. 11 is a side cross-sectional view illustrating yet another insulator 32 having a different coupling structure of a first side plate 200 and a second side plate 300 from that of the insulator 32 illustrated in FIG. 7.

Referring to FIG. 11, a first overlap portion O1 and a second overlap portion O2 may overlap in a direction parallel to an axial direction. A first contact surface 301 and a second contact surface 302 are in contact with each other. The first contact surface 301 and the second contact surface 302 may have a protruding structure and a groove structure having various shapes engaged with each other. The first contact surface 301 and the second contact surface 302 may be disposed in a direction parallel to a direction perpendicular to the axial direction.

The above-described embodiments can be used in various apparatuses for vehicles, home appliances, or the like.

1-10. (canceled)

11. A motor comprising:
a rotor; and
a stator disposed to correspond to the rotor,
wherein the stator includes a stator core, an insulator coupled to the stator core, and a coil disposed around the insulator,
wherein the insulator includes an upper plate disposed on an upper surface of the stator core, a first side plate extending from one end of the upper plate and disposed on one side surface of the stator, and a second side plate extending from the other end of the upper plate and disposed on the other side surface of the stator,
wherein the second side plate includes a first region extending from the other end of the upper plate and a second region extending from the first region and disposed on a lower surface of the stator,
wherein the second region is bent from the first region,
wherein the first side plate includes a third region extending from the other end of the upper plate and a fourth region extending from the third region,
wherein an end of the fourth region includes a first overlap portion having a thickness smaller than a thickness of the third region,
wherein an end of the second region includes a second overlap portion having a thickness smaller than a thickness of the first region,
wherein the first overlap portion overlaps the second overlap portion in a direction parallel to an axial direction,
wherein the first overlap portion includes a first contact surface,
wherein the second overlap portion includes a second contact surface in contact with the first contact surface, and
wherein the first contact surface and the second contact surface are obliquely disposed with respect to a direction perpendicular to the axial direction.

12. The motor of claim 11, wherein a position at which the second region is bent corresponds to a boundary between the upper surface and the side surface of the stator core or a boundary between a lower surface and the side surface of the stator core.

13. The motor of claim 11, wherein a fold groove is formed between the first region and the second region.

14. The motor of claim 13, wherein the fold groove is disposed to correspond to a boundary between the upper surface and the side surface of the stator core or a boundary between a lower surface and the side surface of the stator core.

15. The motor of claim 11, wherein the first overlap portion is disposed closer to the stator core than the second overlap portion.

16. The motor of claim 11, wherein the second overlap portion is disposed closer to the stator core than the first overlap portion.

17. The motor of claim 11, wherein the insulator include an inner guide and an outer guide, and the second region is disposed apart from the inner guide and the outer guide.

18. The motor of claim 11, wherein the insulator include an inner guide and an outer guide, and the fourth region may be disposed apart from the inner guide and the outer guide.

19. The motor of claim 11, wherein a fold groove is disposed between the fourth region and the third region.
